(19) United States
(12) Patent Application Publication
(10) Pub. No.: US 2004/0204222 A1
(43) Pub. Date: Oct. 14, 2004

(54) Game software conversion for lottery application

(76) Inventor: Brian John Roberts, Carlsbad, CA (US)

Correspondence Address: KENYON & KENYON, ONE BROADWAY, NEW YORK, NY, 10004, US

(21) Appl. No.: 10/728,219

(22) Filed: Dec. 3, 2003

Related U.S. Application Data
(60) Provisional application No. 60/430,551, filed on Dec. 3, 2002.

(51) Int. Cl. A63F 13/00

(52) U.S. Cl. 463/17

(57) ABSTRACT

A gaming system for the play of lottery is disclosed. The gaming system may include a lottery ticket having a removable portion concealing instant game information and information for the play of an interactive game. A method for facilitating the play of a lottery game is also disclosed. The method may include providing both instant win and an interactive game using information for a common ticket.

### CROSS REFERENCE TO RELATED APPLICATIONS

This application claims the benefit of U.S. provisional application Serial No. 60/430,551, filed on Dec. 3, 2002, which is expressly incorporated herein in its entirety by reference thereto. Related U.S. Pat. No. 6,477,251, filed Nov. 25, 1998 and U.S. patent application 2003/0045340, filed Sep. 6, 2002 are also expressly incorporated herein in their entirety by reference thereto.

A portion of the disclosure of this patent document contains material which is subject to copyright protection. The copyright owner has no objection to the facsimile reproduction by anyone of the patent document or patent disclosure as it appears in the Patent and Trademark Office patent file or records, but otherwise reserves all copyright rights whatsoever.

### BACKGROUND INFORMATION

The legality of using the Internet to promote gaming in general has generated much debate and caused the creation of legislation prohibiting such use in various jurisdictions worldwide. Primarily such legislation has been borne out of concern for issues such as, e.g., the protection of minors including access control to prevent minors from playing; jurisdiction protection including the control of access from outside a jurisdiction; and protection from compulsive use including access control for those who may have a compulsive gambling problem. These are the issues that have unfortunately created a preconceived image of a minor in California or elsewhere, playing the New York or New Zealand lottery with a stolen credit card.

### BRIEF DESCRIPTION OF THE DRAWINGS

The objectives and features of the invention will become more readily apparent from the following detailed description taken in conjunction with the accompanying drawings in which:

Fig. A illustrates an exemplary flow chart depicting an exemplary process of playing a game, according to an example embodiment of the present invention;

Fig. T illustrates an example game ticket, according to an example embodiment of the present invention.

FIG. 1 illustrates an exemplary flow chart depicting the interaction between the game application software (GAP) and the lottery authority application software (LAP), according to an example embodiment of the present invention;

FIG. 2 illustrates an exemplary system network diagram, according to an example embodiment of the present invention; and

FIG. 3 illustrates a diagram showing the interaction between a user and the LAP, according to an example embodiment of the present invention.

### DETAILED DESCRIPTION OF EXAMPLE EMBODIMENTS

Some of the embodiments of this invention relate to gaming and entertainment systems, applications and associated components and methods.

One aspect of an example embodiment of this invention is the game design of the hybrid instant tickets which may be as varied as the conventional instant tickets that are marketed by lotteries today. For purposes of describing the invention in one exemplary embodiment, a game with a golf theme called “The Back Nine” will be used. It will be appreciated that any new or existing interactive or video game may also be used.

Fig. A illustrates an exemplary flow chart depicting an exemplary process of playing a game, according to an example embodiment of the present invention. In 1, a player may tender cash to a lottery terminal or a salesperson operating a lottery terminal in return for a hybrid game ticket. In 2, the player may receive the hybrid game ticket. The hybrid game ticket may include an instant game part and an access code that may be used for extended play, e.g., over the Internet. In 3, the player plays the instant game portion of the ticket. If the player is a winner of the instant ticket as shown in 21, the player may redeem the instant ticket for a prize in 22 and then the instant portion of the game ends in 23. If the player is not a winner, the instant portion of the game ends in 23. Those of skill in the art will appreciate that the instant game portion of the ticket does not have to be played prior to the extended play game, but could be played afterwards. Once the instant game portion of the ticket is complete, in 4, the player is connected to a game server through a personal device. This connection may be, e.g., through the Internet. In 5, the access code from the ticket is input. This may be by typing a code, scanning a bar code, reading an RFID tag, or other conventional input mechanisms. Next, in 6, the game is played through the connection, e.g., online. In 7, it is determined whether the player is a winner of the extended portion of the game. If the player is not a winner, the game ends and in 9, the player is notified as such. If the player is a winner, in 10, the player may either continue play and receive additional game credits to do so as in 8, or the player may elect to not continue play and redeem the credits remaining. The credits may be redeemed either, e.g., online or with the actual hybrid ticket. Once the player redeems the credits and chooses not to continue play, the game ends and in 9, the player is notified as such.

Some example embodiments of this invention described herein prevent the abuse of the lottery system and effectively utilizes the Internet through the development of a hybrid instant ticket and interactive real-time computer game.

In one exemplary embodiment, the hybrid game originates as an instant lottery ticket being played just like a conventional instant ticket. However, the game contains an extended or additional play element that may be delivered via the Internet as a user's access device, e.g., personal computer (PC), Web TV, personal digital assistant (PDA), mobile phone, etc., upon request and played in an interactive real-time mode.

Generally lottery games are limited to games of chance, whereby the outcome and the award of prizes do not involve skill. However, some jurisdictions do allow skill based games and such skill based games can also be applied to the system and method of operation in an example embodiment. Furthermore, both lottery games of chance and skill-based games may be designed and implemented using the system and methodology an example embodiment to permit two or more players to play against each other or in a tournament type format in an interactive lottery game.

The game may be played using an instant lottery ticket with an extended or additional interactive play element that may be delivered over the Internet. For example, the game may have two parts: i) the instant play portion, and ii) an extended play portion provided by the computer or Internet game. Fig. T illustrates an example game ticket, according to an example embodiment of the present invention. Example ticket T0 may include both an instant-win or scratch-off game similar to a conventional instant-win ticket and information enabling the player to play an extended play interactive or online game. The ticket may be made using a printable substrate such as paper or plastic, or may be electronic, or in some other form. Example ticket T0 may include a game play area T1 located on the substrate and hidden by a removable layer, such as a peel-away or scratch off layer. Game play area T1 may include various instant win game indicia, e.g., a matching game as shown, bingo, or other conventional instant win games. Also included under the scratch off layer may be a machine readable code T2 and/or a human readable code T3. These codes may be used to validate the instant-win portion of the lottery ticket when the ticket is presented for redemption. Also included on the ticket T0 may be a second machine readable code T5 and a human readable counterpart code T4. This second machine readable code may include interactive game information for the play of the extended interactive play game. This information may include an access code to be utilized by the player for playing the interactive game, an address, such as an Internet Universal Resource Locator for the player to locate where the extended game is to be played, as well as information used in the play of the extended game. It will be appreciated that other features may be included on the ticket, e.g., inventory control information, instructions for playing the game, advertising information, additional security devices, etc. It will be appreciated that the illustrated arrangement is only exemplary, and that the instant and interactive play information may be combined in a single machine readable code, located in different locations, e.g., on the reverse of the ticket, or in some other form, e.g., using an RFID tag, machine readable symbols, or other approaches. The interactive play information may also be provided on a separate ticket, e.g., a trailer ticket which is sold together with a conventional instant win ticket. The interactive play information may also be provided on a separate, removable portion of an instant win ticket—e.g., on the peel off layer, or on a tear off portion of the ticket, so that the instant win ticket may be tendered for redemption while still allowing the extended play portion of the game to be played at a future time.

The price of the ticket, e.g., $3, may reflect the instant play portion and the extended play portion, such as, for example, $1 and $2 respectively. The exemplary $2 extended play portion may provide two additional chances of winning through the extended play game. It will be appreciated that instant and extended plays must be sold separately or might only be priced as a single use.

The instant ticket may be purchased from an authorized lottery retailer and may be played just like any other instant lottery ticket. However, the extended play portion of the game may be played interactively on an Internet access device at the player's home, office or anywhere that the player may have Internet access or other forms of distributed access to a game server.

Upon authorized access for the extended play portion, an interactive and graphically exciting game such as, e.g., a golf game, may be downloaded to the access device for the player to play. The player may now play game, e.g., the nine holes of golf, in an interactive manner for an extended period of time. The objective of playing the lottery aspect of the golf game may be to match a hole score that is randomly generated by the system upon completion of each hole. Although the golf game may require an element of skill the lottery game may be purely based on a random result. Like most instant games the game may be designed to provide a high frequency of winners, and the player may be able to play additional games, e.g., by winning free plays or by reinvesting the winnings in additional plays. Remaining prize money may be collected by presentation of the original instant ticket at any lottery retailer, or by submitting a claim form over the Internet.

The above describes an example hybrid internet instant ticket. The concept addresses and provides lotteries wishing to offer an Internet based product. Using an instant game type format, players will be able to adapt to the new play format without extensive player education. The initial purchase may be made from an established lottery retailer, which may require cash and thereby does not require legislative change to allow credit payment for a gaming purchase. Payment in cash to the lottery retailer may limit the potential abuse of payments made by credit, even if it were legal. Because the retailer is involved in the transaction, the retailer may still receive a commission and be supportive of the lottery's program, whereas if removed from the transaction, the retailer may protest by stopping the sale of other lottery products. Additional lottery products provide the retailer with additional opportunities to earn increased commissions. Purchasing the initial ticket from the retailer provides safeguards and controls play by minors. Purchasing the initial ticket for cash and allowing extended and additional play against prize winnings again eliminates the need for payment using credit and provides a control in that the player may only continue to play until all winnings are exhausted. Purchasing the original ticket at an authorized lottery retailer eliminates the issue of jurisdiction while allowing the player access even if he resides in a different jurisdiction from where the ticket was purchased.

The example game may employ existing instant game themes to which players may be accustomed while allowing Internet capabilities to provided additional and extended play to those themes. A wide range of entertaining and graphically exciting games such as, e.g., card games, strategy games, sports games, etc., may be modified for lottery play and priced accordingly to reflect the extent of prolonged play and entertainment value. For example, nine holes of golf on a par 4 course may provide 15 to 30 minutes of extended play value while a blackjack card game may provide faster action but may provide the player with, e.g., 20 hands for an initial $1 purchase. Naturally, prize payouts may vary across game formats but preferably may be large enough to fund an additional play.

Furthermore, while most prizes may be small to facilitate extended play, a progressive jackpot may be included to further enhance the excitement of play. In the “The Back Nine” golf game exemplary embodiment, for example, if each hole had the possibility of between 1 and 6 strokes as the score, and the objective to win the jackpot prize were to match exactly the match play scores generated by the system for each hole, the odds of winning the jackpot prize would be 1 in 10,077,696. These may be long odds, a progressive jackpot prize downloaded to each user's access device provide the user with the increased excitement of potentially winning the jackpot prize as each hole is played, in addition to winning a smaller prize.

It is believed that this type of play utilizing the Internet may appeal to the new generation of lottery players, a group for whom computers and the Internet present an increasingly important role in their lives. This generation of computer savvy players is looking for the thrill and entertainment value of these interactive games. They are also more attuned to being members of a player's club especially if such membership provides additional benefits through competitive challenges. For instance, in the golf game example, players playing a golf game over the Internet may elect to have a particular game entered into a separate competition open only to player's club members. During the days of play of the major professional golf tournaments the player may nominate one of his games to be entered. The best score may receive points and at the end of the golf season the players with the most points may win a prize or prizes, which could be, e.g., a golf vacation, a round of golf with a professional, golf lessons or golfing and/or lottery merchandise.

Moreover, there is also potential to include corporate sponsorship. Such prizes may be sponsored by, e.g., a golf manufacturer or supplier. In fact, the initial instant lottery ticket may display the sponsor's logo. In addition to this promotion of the sponsor, the game software may be modified to further promote the sponsor during the computer game play. For example, the fairways may be lined with the sponsor's flags or a billboard may display an advertisement. Furthermore, the computer game may also have a “game within the game” feature. With such a feature the player whose score matches certain criteria (e.g., a hole in one) or upon the occurrence of certain events the player may win a sponsored prizes such as, e.g., a golf club or set of golf balls. In this scenario the player may be delivered to the sponsors web site at the end of the game for prize fulfillment. Regardless, of the win/loss outcome of the “game within a game,” the player may be invited to the sponsor's web site for other promotional activities.

In another aspect, an exemplary embodiment of this invention includes the system and methodology to modify popular, commercial computer based games for lottery play in an interactive real time play mode anywhere that the player may have access to the Internet.

For those jurisdictions where payment on credit is illegal the game may be packaged as an extended play feature of an instant lottery ticket that may be delivered to the player via the Internet. The instant ticket may be purchased from an authorized lottery retailer and played just like any other instant ticket. However, the extended play portion of the game may be played interactively on an Internet access device, e.g., PC, mobile phone, PDA, etc. at the player's home or office, or anywhere the player has Internet access.

In lottery jurisdictions where payment for lottery tickets is acceptable via credit or debit card or through arrangements with a financial institution or through the prior establishment of a deposit account with the lottery, a game may simply be purchased and activated over the Internet.

The following provides an overview of one embodiment of a methodology whereby most video games that are commercially available may be securely adapted into a lottery game of chance. Even a video game were the outcome is determined by the player's skill level may be modified to add the dynamics of monetary or other prize rewards while conforming to the legal mandates required of government authorized lotteries.

The development of a video game is significant and time consuming and as such presents real barriers to the development of games specifically for the lottery industry. The system and methodology disclosed herein enables the cost effective, efficient and secure modification of any video game for lottery play. It is appreciated that specifications and standards may be developed such that any video game may be cost effectively modified for lottery play. It is appreciated that the management, marketing and operation of games and gaming systems with lottery authorities worldwide.

In all video games, events happen during the normal course of play that have several possible outcomes. Therefore, a series of events may be identified in a particular video game. As play progresses, the outcome, or result, of the event may be passed to the lottery application as it occurs. Each result is then compared to a corresponding event result that may be generated randomly by the lottery application upon activation of the game, e.g., progressively during the game as each event occurs. Standards and specification documentation provide the necessary information for any game software designer to modify a video game in conformance with the lottery standards developed according to this invention. Such modified games may then be submitted for validation, authentication and possible presentation to lottery jurisdictions.

The example gaming system of this aspect of the invention may include three discrete sub-systems: i) a server (central system) software, which may be a secure fully redundant system containing the various databases required for game play transaction processing; ii) a lottery authority application software (LAP), which is the interface between the server and the game software; and iii) a game application software (GAP), which may be the modified lottery version of the commercially available software. It will be appreciated that other architectures may also be employed, e.g., using the methods and structures described below.

Example Procedure For Facilitating Game Play

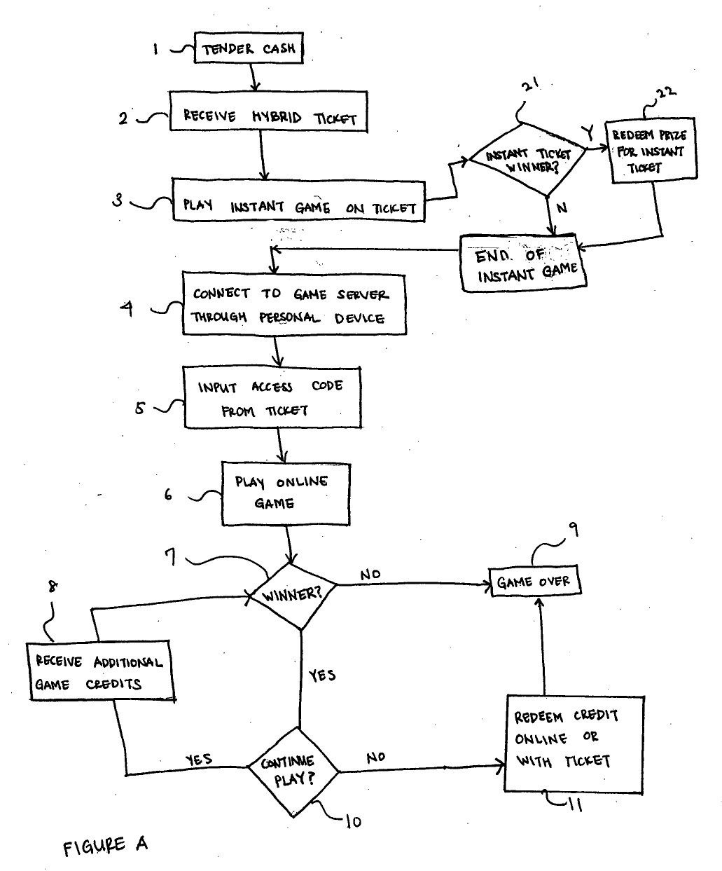

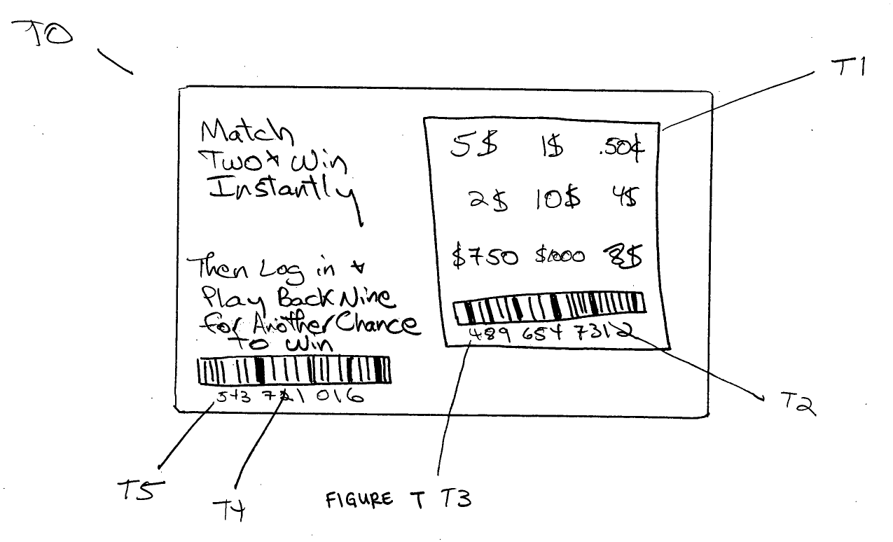

FIG. 1 illustrates an exemplary flow chart depicting the interaction between the GAP and the LAP according to an example embodiment of the present invention. The GAP may have a set of GAP processes 100 and the LAP may have a set of LAP processes 120. The GAP processes 100 begin by starting the game in 101 that the user will play. Once the game is started, in 102, the number of events loop counter is set. Next, in 103, the value of the number of events is checked, e.g., whether it is zero. If the events are zero, in 104, the player is notified that the game is over. If, on the other hand, the events are not equal to zero, the events are played in 105. In 106, the GAP checks whether the event is complete. If the event is not complete, the process will loop back to 105 and continue to play the event. If the event is complete, the event results are sent to the LAP in 107 and 108. In 109, the response from the LAP is awaited. Once the response is received, in 110, the response is checked to verify whether the response is valid response. If the response is not valid, the GAP awaits another response. If the response is a valid response, in 111, the player's screen is refreshed and the lottery window is displayed to the player. Once the event is complete, in 112, the event loop counter is reduced by one and the GAP again checks whether the events are equal to zero as in 103.

Once the LAP receives the event results from the GAP in 107 and 108, the GAP accesses the game/ticket record and compares the event result from the GAP to the event result from the LAP in 121 from the game/ticket database 50. The event results in the game/ticket database are generated in 126 as will be discussed further below. In 122, once the event results from the GAP and the event results from the LAP are retrieved by the LAP, the LAP checks whether the event results are equal. If the two event results are equal, the LAP gets the prize data, updates the lottery window and sends this information to the GAP in 124 and 128. If the event results are not equal, in 123, the LAP checks whether there are any events remaining. If there are more events, in 126, the LAP generates the next event result and records it in the game/ticket database 50. On the other hand, if there are no more events remaining, the game ends as in 125.

It will be appreciated that other steps may be added and the existing steps may be re-ordered in this example procedure.

Example Game System

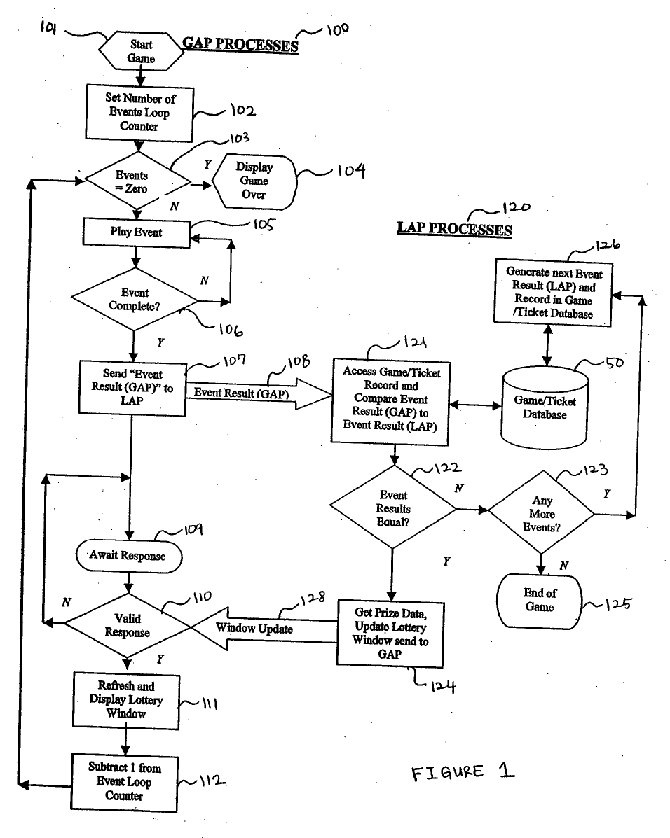

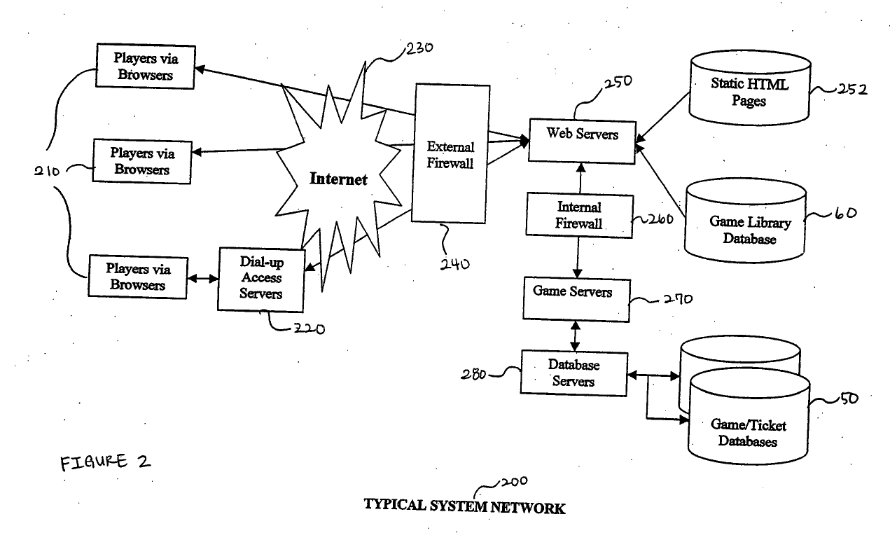

FIG. 2 illustrates an exemplary system network diagram according to an example embodiment of the present invention. The system network illustrates a number of browsers 210 from which players may access the Internet 230. These browsers 210 may be, for example, a personal computer, a personal digital assistant, a mobile phone, a web television, a game console or any other Internet access device. FIG. 2 illustrates one of the players accessing the Internet 230 via a dial-up access server 220. Those skilled in the art will recognize that there are numerous types of browsers as well as numerous ways in which a player may access the Internet 230. The Internet 230 connects the players browsers 210 to web server 250. The Internet 230 is protected by an external firewall 240. This firewall 240 may prevent unauthorized access to and from the web server 250 as is known in the art The web server 250 retrieve information from static hypertext mark up language (HTML) pages database 252 and game library database 60. The web server 250 also retrieves information from game server 270. The connection between the game server and the web server 250 is also protected by an internal firewall 260. The game server 270 communicates with database server 280 which retrieves information from the game/ticket database 50 which stores the game/ticket information as described in reference to FIG. 1.

It will be appreciated that the system network may include other communication between the player browser and the LAP. In addition, those skilled in the art will recognize that the system network may be operated by the player on other devices such as personal digital assistant displays, cellular phone displays, etc.

Additional Example Procedure for Facilitating Game Play

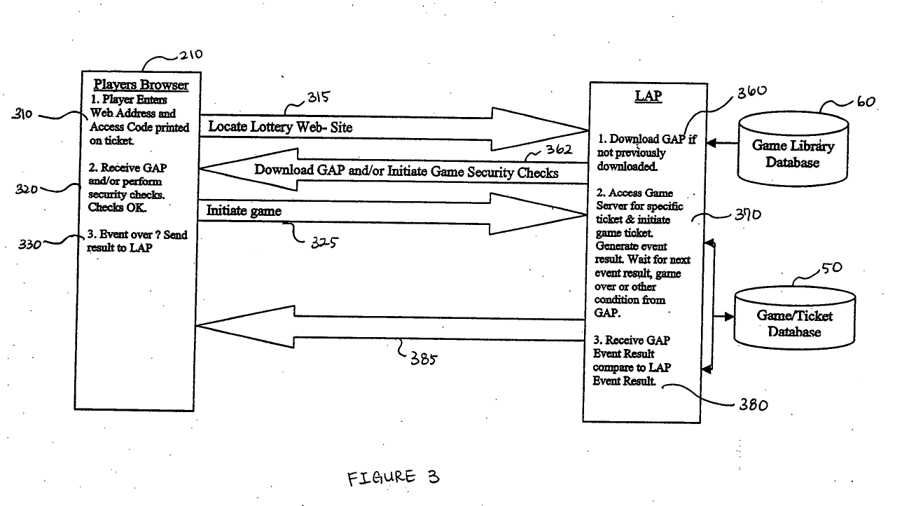

FIG. 3 illustrates a diagram showing the interaction between a user and the LAP according to an example embodiment of the present invention. In 310, the player may enter the web address and access code that may be printed on the ticket. This may be done using the player browser 210 but it will be appreciated that other devices may be used such as, e.g., PDA displays, mobile phone displays, etc. In 315, the player browser 210 may locate the lottery web-site or location where the lottery information may be accessed. In 360, the LAP downloads the GAP if it has not been previously downloaded. This may be done from, e.g., the game library database 60. In 362, the LAP may initiate game security checks. In 320, the player browser 210 or other display device receives the GAP and/or performs the security checks. Once the security checks are complete, in 325, the game is initiated. In 370, the LAP then accesses the game server for the specific ticket and initiates the game ticket. The LAP then generates the event result and waits for the next event result, game over or other condition from the GAP. As described above in reference to FIG. 1, in 106, the GAP checks whether the event is complete. If the event is complete, in 330 and 107 and 108 of FIG. 1, the results are sent over to the LAP. Finally, in 380 and 121 in FIG. 1, the LAP receives the GAP event result and compares those to the LAP event results. As described above, this may be done by retrieving information from the game/ticket database 50.

It will be appreciated that other steps may be added and the existing steps may be re-ordered in this example procedure.

A secure lottery version of game software is only available for download from the lottery authority's game site and may only be executed (playable) with an authorized security key that is provided by the LAP when the game is downloaded or made available at sign-on. The lottery version of game software may be modified such that the game is played interactively: It may only be played upon input and validation of authorized access codes and security keys. The game graphics may be modified to provide a lottery status window to display information regarding the lottery game play. A series of events have been identified for monitoring and reporting during game play. A set of possible outcomes (results) for each event has been identified. As each event is completed the resultant outcome is sent to the game server for recording and determination of the win/loss outcome. The data pertaining to the win/loss outcome is displayed in the lottery window of the game graphics.

After each event play, the game status data, together with date and time stamp and other data security information is sent to the game server by the LAP in 107 and 108. In 121, it is then recorded to enable later reconstruction for security and audit or re-start in the event of a lost communication link (e.g., power failure, player signs of for suspends play). If game play is interrupted for any reason, (e.g., lost link or player switches off) it may be restated from the last checkpoint data in the server.

As described above in reference to 107 and 109, the outcome of each event play is passed from the GAP to the LAP and to the game server event by event, and where the win/loss outcome is determined in real-time and with the result for the event being transmitted from the game server to the LAP. This process provides a significant level of security as win/loss data is created only as it is required for each event and thus limits and prevents unauthorized access to the game data. All event data may also be encrypted. As each event is played, the result may be displayed in the lottery status window to the player together with any prizes that have been won up the current event as in 111. To ensure that each game is played to completion the prize structure may include a prize (e.g., a free play) for any game play, which results in one correct event. If the prize structure does not provide for a “one correct event” prize level then the game should be terminated with the message “game over.” If the player suspends the game once the number of events remaining is insufficient to win a prize.

In the event that communication is lost for any reason and the game play has reached a point where the number of remaining events is insufficient to win a prize, the game's status may be flagged as “game over.” Any subsequent attempt to restart by the player may result in “game over” being displayed. As prizes are awarded, credits may be accumulated and displayed to the player. At the end of each game any accumulated credits may be made available to the player to re-invest in additional game play, or the player may take the original instant ticket to a lottery retailer for prize validation and collection. Should the player choose to re-invest in another game, payment is deducted from the available credits and a new game commences. The new game may generate data specific to the new game play but the data may be concatenated to the original ticket's serial number for account tracking, audit and payment validation.

It is recognized and also incorporated in this system and methodology that game software may be modified such that the outcome of each ticket is pre-determined and that game initiation may simply supply the “seed” for the game outcome algorithm. Hence the game may then be completed without interaction with the central system. However, the above-described interactive, or “on-line”, methodology provides additional levels of data security and integrity for development of games that incorporates a progressive jackpot in the game's prize structure.

Although the initial embodiment of this invention is based on lottery games of chance, it is also recognized that some jurisdictions do, or may in the future, allow skill-based games. Therefore, the system and methodology to create interactive real-time lottery games described herein may be applied to games of skill and where skill becomes a factor in determining the win/loss outcome.

The golf game embodiment will be used to illustrate this aspect. In the chance based game the player's score for each event (hole) is transmitted to the game server for win/loss determination by matching to a random result generated in real time after the player has played the hole. In a skill based game the game server will randomly generate a result prior to the player's play. The result being sent to the game application and the player will now try to beat or match the result in order to win. A matching score would win a prize at one level and a higher-level prize would be won if the player beat the score.

Furthermore, it is also envisioned that where legislation permits, games may also be designed in the form of a tournament. Under such a game structure, players having purchased their ticket or entry via one of the ways described above may log-on and sign-up to play in a scheduled game. The player may then be paired with another player or to a foursome as in the exemplary golf game scenario described above. Players may then play against each other according to tournament rules, with the players' scores being tabulated as the tournament continues from round to round until the tournament winner is decided. Prizes in the form of cash or merchandise may be awarded by the lottery authority to the winner and runners-up. Players may be ranked on their tournament results and may qualify for a “Masters Series” where the player may be able to win a progressive jackpot prize.

In another embodiment of this invention, the events to determine the win/loss outcome may be in the form of “betting odds.” For example, in a tournament football game the player may be presented with the odds of each event being provided, e.g., the score at the end of the first quarter may be presented as, for example, a 7-7 tie has 2 to 1 odds, 14-0 score has 5 to 1 odds, 0-14 score has 5 to 1 odds and so on. Players may then select the events (bets) that they wish to play.

Again, the possibility of the system and methodology to modify a computer game of chance or skill into an exciting game for use by lotteries or other gaming authorities worldwide is virtually unlimited.

The modifications to the game application software (GAP) and interaction with the lottery application software (LAP) are shown in FIG. 1 as an event play flowchart and interaction between the GAP and the LAP as described above. Each game may be modified to create a lottery version with the following features and functions. The GAP software may be modified such that it is only executable by two access codes. The first access code may be specific to the lottery, which may be downloaded at sign on. The second access code may be specific to the ticket, which the player input from the ticket.

The GAP software may be modified to provide a lottery window, which may be displayed as an overlay or pop-up window on a section of the game display. The window may provide game status feedback to the player pertinent to the lottery aspects of the game such as, e.g., total prize or credits, last win, events won, progressive jackpot amount, etc.

Instructions on how to play and/or frequently asked questions pertinent to the game may or may not be embedded in the GAP but may be supported by the LAP.

The GAP software may be modified to identify, monitor and report on the number of specific events for the game. In the nine hole golf example discussed above, the number of events may equal nine or optionally ten. Additional events independent to the regular events may also be established to award additional prizes or a jackpot prize. For example, in the nine hole golf game event, ten might be the cumulative number of strokes taken for the nine holes. The range of results possible for each event must be identified. In the nine-hole golf game; each hole may result in a number of strokes being taken. This specific game allows the resultant outcome to be in the range, for example, of 1 through 6, where 1 equals a hole-in-one, 2 a hole-in-two and so on up to 6, which is 6 or a greater number of strokes. The optional tenth event in this example may be a number in the range of 9 through 99, where the minimum 9 may mean the player got nine holes-in-one, and the maximum 99 may mean the play took the maximum number of shots on each hole. In this example the maximum shots per hole is 11. At the completion of each hole the event result is passed by the GAP to the LAP as shown in 107 and 108 of FIG. 1.

As described above in reference to FIG. 1, upon receipt of the event result from the GAP by the LAP, the LAP may access the game/ticket database 50 and extract the appropriate game ticket data and perform the following processes. In 122, the event result from the LAP may be compared to the event result from the GAP. If the results are equal, the player has won a prize for that event. The LAP may access a prize payment table (not shown) and in 124, extract the appropriate prize (e.g., number of credits won) for the event. The LAP may update the lottery window with the event prize and the cumulative prize (e.g., credits) won, and may send the window to the GAP to refresh the lottery window on the browser display as in 124 and 128. Prior to sending the updated lottery window to the GAP, the LAP may record the updated data for the ticket in the game/ticket database 50, and may determine if the game is complete or more events remain to be played in 124. If there are no more events, in 125, the lottery window may be accompanied with a “Lottery Game Over” message for display on the browser. Although the lottery game aspect of the game is over, the game may be continued in a non-lottery mode, e.g., it may be played for additional entertainment without interaction with the LAP and without the excitement of winning lottery prizes. If events remain to be played, in 126, the LAP may generate the result of the next event result (LAP) and record it in the game/ticket record. The event result from the LAP are not sent to the GAP. After the next event result has been generated by the LAP and recorded in the game/ticket database 50, in 1245, the lottery window is sent to the GAP to refresh the lottery window, and resume game play.

At the end of a game if the credits (prizes) have been won in the last or previous games, the credits may be used to purchase another game. If another game is purchased, the process starts over with the appropriate number of credits being deducted to cover the cost of the game. A new game data record is created in the game/ticket database 50 linked to the original game ticket.

The above-described methodology provides a secure way for the modification of video game software for use in a lottery application. The security and integrity of the lottery is maintained through the structure and interaction of the processes as follows. The video game software GAP is modified such that it recognizes, monitors and outputs certain predefined events that occur naturally during game play. The game may only be activated and played upon the input by the player of a valid access code printed on the lottery ticket, or by an account number if this method of play is legal in the lottery jurisdiction. The LAP event results, may be randomly generated immediately prior to each event occurring in the GAP. This means that at any point in time only the result of one incomplete event may be known and recorded in the game/ticket database 50. Therefore, in the most unlikely event that the lottery system and the LAP were compromised, the extent of the security breach would only be the result of the next event. Military-grade encryption may be used throughout the system to protect data and detect tampering attempts. Furthermore, the event result generated by the LAP may never be sent to the GAP and may never be communicated outside of the LAP process 120. The lottery version of the game software (GAP) may be signed and encrypted to ensure that only authentic program versions are executed. The overall system architecture may provide for an internal firewall 260 and external firewall 240 as shown in FIG. 2 for a typical system network 200.

In another exemplary embodiment, a player may simply purchase a ticket that provides access to the extended interactive portion of the game rather than a hybrid ticket. The player may purchase the ticket in numerous ways, such as, for example, from an online ticket vendor, a lottery terminal, a website, etc. The ticket may or may not have a scratch-area. For example, the scratch-off area may conceal the access code to be used for the interactive game, e.g., online. Alternatively, the ticket may not need a scratch-off portion since the access code need not be concealed. In this exemplary embodiment, the tickets may not have security codes under scratch-off areas since tickets purchased online do not need to be pre-printed and thus may not create the risk of fraud or misuse. Instead, the player may generate and print an online ticket or simply an entry or access receipt, e.g., at an online terminal, a personal computer printer, any other online printing device, etc., at or after the time of purchase.

In the preceding specification, the present invention has been described with reference to specific example embodiments thereof. It will, however, be evident that various modifications and changes may be made thereunto without departing from the broader spirit and scope of the present invention as set forth in the claims that follow. The specification and drawings are accordingly to be regarded in an illustrative rather than restrictive sense.

What is claimed is:

1. A lottery gaming system comprising:
a lottery ticket having a removable portion concealing instant game information, a bar code and an interactive game information portion;
a lottery ticket dispenser having a bar code reader for reading the bar code on the lottery ticket prior to the lottery ticket being dispensed from the dispenser;
a central computer system in communication with the lottery ticket dispenser;
wherein transmittal of the bar code from the lottery ticket dispenser to the central computer system initiated interactive game information represented on the lottery ticket in the interactive game information portion; and
a computer remote from and in communication with the central computer system, the computer being utilized by a player to play an interactive game with the central computer system based on the interactive game information.

2. The lottery gaming system of claim 1 wherein the lottery ticket dispenser further comprises:
a printer for printing the interactive game information on the lottery ticket in the interactive game information portion.

3. The lottery gaming system of claim 1 wherein the computer is in communication with the central computer system via the internet.

4. The lottery gaming system of claim 1 wherein the interactive game information further comprises:
an access code to be utilized by the player for playing the interactive game; and
an address to be utilized by the player for accessing the central computer system.

5. The lottery gaming system of claim 1 wherein the computer is remote from the lottery ticket dispenser.

6. The lottery gaming system of claim 1 wherein the computer is incorporated into the lottery ticket dispenser.

7. The lottery gaming system of claim 1 wherein the interactive game information is pre-printed on the lottery ticket and activated when the bar code is transmitted to the central computer system.

8. A lottery ticket comprising:
a removable portion to reveal instant game information for determining whether the lottery ticket is an instant game winner;
a bar code; and
an interactive game information portion for displaying interactive game information required by a player in playing an interactive game.

9. The lottery ticket of claim 8 wherein the interactive game information further comprises:
an access code to be utilized by the player for playing the interactive game; and
an address to be utilized by the player for accessing the interactive game.

10. The lottery ticket of claim 8 wherein the removable portion is a scratch off layer.

11. The lottery ticket of claim 8 wherein the lottery ticket is releasably coupled by lines of weakness to additional lottery tickets in a fan fold stack of lottery tickets.

12. A method of conducing a lottery comprising the steps of accepting payment from a player;
processing a selection by the player for a lottery ticket;
wherein the lottery ticket includes a removable portion concealing instant game information, a bar code, and an interactive game information portion for displaying interactive game information required by a player in playing an interactive game;
reading the bar code from the lottery ticket;
generating interactive game information associated with the bar code;
initiating the interactive game information on the lottery ticket;
dispensing the lottery ticket to the player;
removing the removable portion from the lottery ticket;
determining if the lottery ticket is an instant game winner;
redeeming a prize if the lottery ticket is the instant game winner;
accessing the internet with the interactive game information; and
playing the interactive game via the internet.

13. The method of claim 12 further comprising:
transmitting bar code information of the bar code to a central computer system

14. The method of claim 13 wherein the generating step is performed by the central computer system.

15. The method of claim 12 wherein the accepting, processing, reading and dispensing steps are performed at least in part by an automated ticket dispenser.

16. The method of claim 15 further comprising:
providing a communication link between the automated ticket dispenser and a central computer system located remotely from the automated ticket dispenser.

17. The method of claim 15 further comprising:
transmitting bar code information on the bar code from the automated ticket dispenser to the central computer system.

18. The method of claim 12 wherein the removing, accessing and playing steps are performed at least in part by the player.

19. The method of claim 12 further comprising:
printing at least a portion of the interactive game information on the lottery ticket in the interactive game information portion.

20. The method of claim 19 wherein the printing, accepting, processing, reading and dispensing steps are performed at least in part by an automated ticket dispenser.

21. The method of claim 12 wherein the accessing and playing steps are performed at a location remote from the dispensing step.

22. The method of claim 12 further comprising:
crediting an account of the player if the player wins the interactive game.

23. A lottery gaming system comprising:
a central server system and associated central server system software including a plurality of databases required for game play transaction processing;
instant-win lottery application software for the redemption of instant-win lottery tickets;
on-line lottery application software adapted to interface between the central server system and associated software and a user interface device for the play of an interactive game, said game being played using information provided with an instant-win lottery ticket; and
game application software for the play of the interactive game.
